(19) United States
(12) Patent Application Publication
(10) Pub. No.: US 2012/0126074 A1
(43) Pub. Date: May 24, 2012

(54) Device Support for a Stringed Instrument

(76) Inventor: Mark Garon, Sainte-Hyacinthe (CA)

(21) Appl. No.: 13/386,795

(22) PCT Filed: Jul. 27, 2010
(86) PCT No.: PCT/CA2010/001163

§ 371 Date: Feb. 9, 2012

Related U.S. Application Data
(60) Provisional application No. 61/228,631, filed on Jul. 27, 2009.

(51) Int. Cl. G10D 3/00

(52) U.S. Cl. 248/220.22

(57) ABSTRACT

A support for temporarily securing a device to a stringed instrument comprises a pair of laterally extending plates coupled together and each having, on one of their sides, at least one layer comprising an elastomeric material. The plates are adapted to be mounted in a clamping arrangement to the portions of the strings extending beyond the nut of the instrument. The sides provided with the elastomeric layers face each other such that the elastomeric material frictionally engages the strings. The support also typically comprises an elongated member preferably pivotally mounted, at one end, to at least one of the plates, and mounted, at the other end, to a holding mechanism which may assume different configurations and which is adapted to hold and support the device.

### CROSS-REFERENCE TO RELATED APPLICATIONS

The present patent application claims the benefits of priority of U.S. Provisional Patent Application No. 61/228,631, entitled “Device Support for a Stringed Instrument” and filed at the United Stated Patent and Trademark Office on Jul. 27, 2009; the content of which is incorporated herein by reference.

### FIELD OF THE INVENTION

The present invention generally relates to supports and more particularly to supports adapted to be mounted to stringed instruments.

### BACKGROUND OF THE INVENTION

Learning to play the guitar or any other stringed instrument is a complex undertaking requiring much repetition. It generally requires, among other things, the memorisation of finger positions, notes, chord sequences, etc. Each note or chord formation generally requires the learning player to remember which strings to pluck, which fret position to press, which strumming pattern to use, what string effect to use and which tempo to follow. It also requires the learning player to know the next coming positions.

All these information can be overwhelming for the novice player. Hence, in order to assist learning players to better process all these information, several electronic learning devices providing a display of some of these information have been proposed throughout the years. Non-exhaustive examples of proposed devices and systems are illustrated in U.S. Pat. Nos. 4,080,867; 4,318,327; 4,915,005; 5,408,914 and 7,355,110. Despite their usefulness, these devices are typically permanently mounted to the instrument, thereby limiting their interchangeability. Indeed, it would often times be practical for the learning player to be able to use such a learning device on another instrument or to quickly replace a learning device by another one on the same instrument.

In that sense, hand-held learning devices have been proposed. However, it is generally cumbersome to use them while playing the instrument

Hence, as is apparent from the foregoing, a need exists for a support mountable to a stringed instrument and adapted to temporarily secure different types of learning devices and other electronic devices.

### SUMMARY OF THE INVENTION

It is a general object of the present invention to provide a support for stringed instruments. According to a preferred though not limitative embodiment of the present invention, the support typically comprises a pair of laterally extending plates, each having, on one side thereof, a layer comprising an elastomeric material. The plates are further configured to be mounted in a clamping arrangement to the portions of the strings which extend beyond the nut such as not to affect the note of the strings.

The plates are mounted to the strings such that their respective elastomeric layers face and preferably contact each other such as to frictionally engage the strings.

To hold and support a device, the support typically further comprises an elongated member pivotally mounted at one end to at least one of the plates, and mounted, at the other end, to a holding mechanism which may assume different configurations and which is adapted to hold and support a device.

In a first exemplary embodiment, the plates are the legs of a generally unitary and elongated U-shaped clamp. In this embodiment, the plates are preferably biased against each other by the relatively semi-circular connecting portion of the U-shaped clamp.

In a second exemplary embodiment, the plates are coupled together by a spring.

In a third exemplary embodiment, the plates are coupled together by a hinge and are further provided with a locking mechanism for locking the two plates together.

Other advantages and novel features of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other objects, features and advantages of the invention will become more readily apparent from the following description, reference being made to the accompanying drawings in which:

FIG. 1 is a perspective view of a first exemplary support in accordance with the invention, the support being mounted to the strings of a guitar.

FIG. 2 is a side view of the support of FIG. 1.

FIG. 3 is a perspective view of a second exemplary support in accordance with the invention, the support being mounted to the strings of a guitar.

FIG. 4 is a side view of the support of FIG. 3.

FIG. 5 is a side view of a third exemplary support in accordance with the invention.

FIGS. 6A to 6C are top views of a fourth exemplary support in accordance with the invention.

### DETAILED DESCRIPTION OF THE PREFERRED EMBODIMENT

A novel device support will be described hereinafter. Although the invention is described in terms of specific illustrative embodiments, it is to be understood that the embodiments described herein are by way of example only and that the scope of the invention is not intended to be limited thereby.

Broadly, in accordance with present though not limitative embodiments of the present invention, the support typically comprises a pair of laterally extending plates, each having, on one side thereof, a layer comprising an elastomeric material. The plates are further configured to be mounted in a clamping arrangement to the portions of the strings which extend beyond the nut of the instrument such as not to affect the note of the strings.

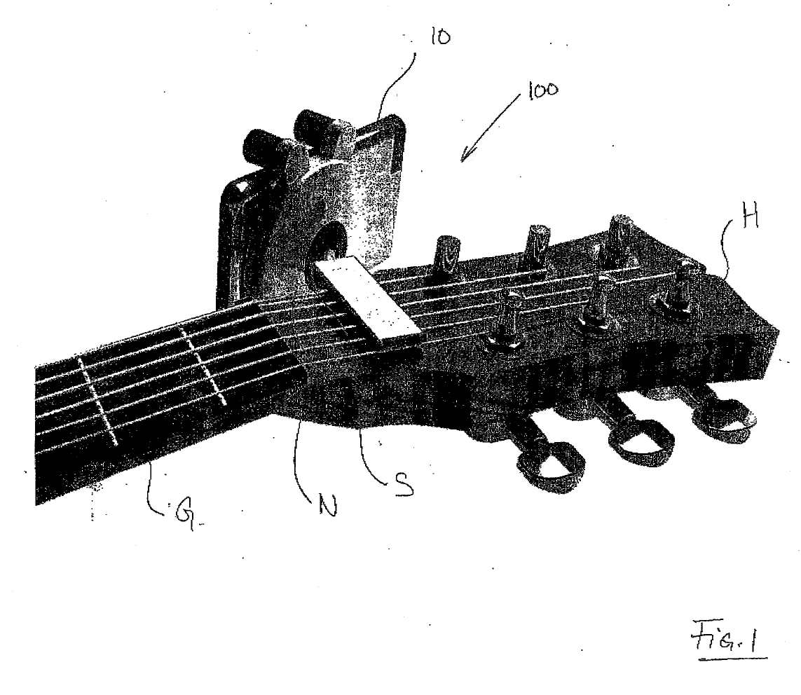

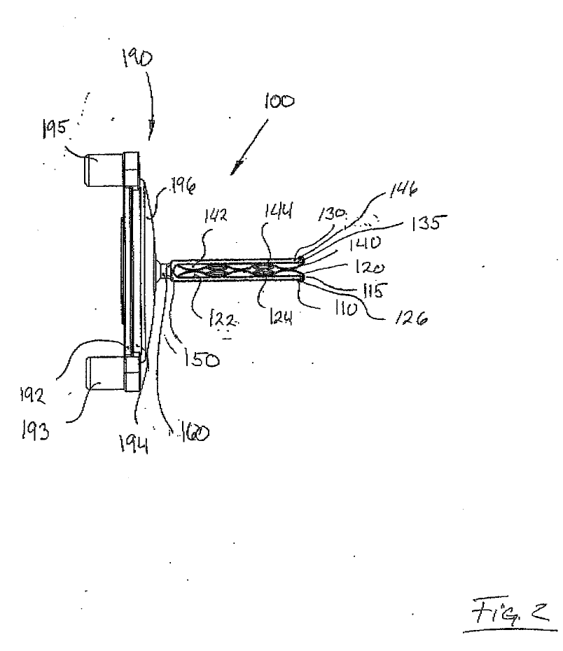

Referring first to FIGS. 1 and 2, a first exemplary support 100 is depicted.

The support 100 generally comprises a pair of laterally extending plates 110 and 130. The plates 110 and 130 are further connected together by a joining portion 150 such as to define an elongated U-shaped clamp. Preferably, the joining portion 150 slightly biases the two plates 110 and 130 toward each other.

Each of the plates 110 and 130 is provided, on one of their sides, with at least one layer of resilient elastomeric material such as, but not limited to, rubber. The elastomeric layers 120 and 140 are positioned such as to face each other and preferably at least partially contact each other as best depicted in FIG. 2.

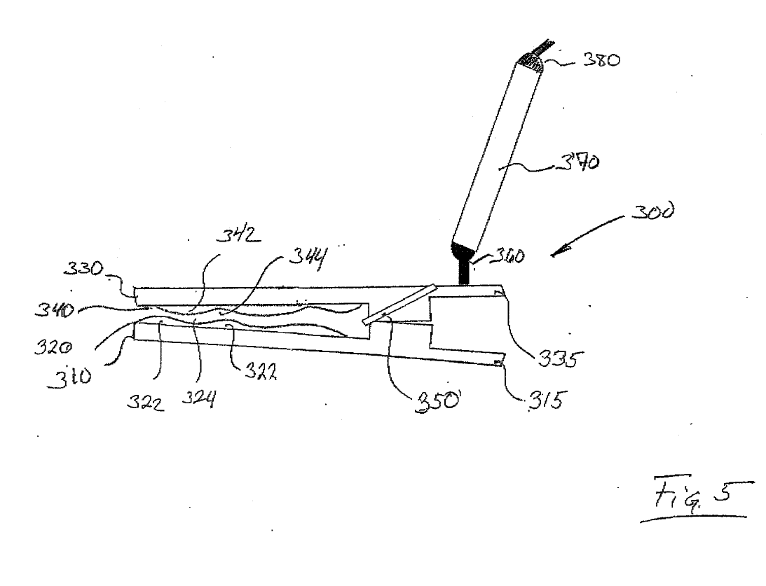

As shown in FIG. 2, elastomeric layers 120 and 140 preferably respectively comprise alternating ridges 122 and valleys 124 and ridges 142 and valleys 144. Ridges 122 and 142 and valleys 124 and 144 are preferably aligned though they could possibly be offset (see support 300 in FIG. 5). Still, the skilled addressee will understand that other layer configurations are possible and within the scope of the present invention. In any case, it is generally important that the layers 120 and 140 can accommodate strings of different sizes. In that sense, the resiliency of the elastomeric material of the layers 120 and 140 generally provides such accommodation.

The elastomeric layers 120 and 140 also provide for a frictional engagement with the portions of the strings S which extend beyond the nut N of the stringed instrument G as best depicted in FIG. 1.

The person skilled in the art will readily understand that since the support 100 is mounted to the portions of the strings S extending beyond the nut N, the notes of the strings S will not be affected by the presence of the support 100.

In addition, in the present embodiment, the plates 110 and 130 are preferably as wide as the nut N of the instrument G. Still, since the support 100 could be used on different types of stringed instruments (e.g. guitar, banjo, bass guitar, etc.), the plates 110 and 130 could be made wider or narrower than the nuts of such instruments. Consequently, the support 100 could possibly overlap only a subset of the strings S or could extend beyond the width of the nut N.

Referring back to FIG. 2, the skilled addressee will note that the elastomeric layers 120 and 140 slightly extend over the free extremities 115 and 135 of the plates 110 and 130. These respective overlapping portions 126 and 146 of the elastomeric layers 120 and 140 are preferably round such as to ease the mounting of the support 100 over the strings S.

The support 100 further comprises a ball joint 160, or any other type of articulated joint, preferably mounted at the joining portion 150 connecting plates 110 and 130. The ball joint 160 is preferably further connected to a holding mechanism 190.

In the present embodiment, the holding mechanism 190 comprises a pair of disks 192 and 194 pivotally mounted together and to a support structure 196. The disks 192 and 194 are respectively provided with at least two diametrically disposed fingers 193 and 195 (only one of each of the fingers 193 and 195 is shown in FIGS. 1 and 2). A biasing mechanism such as a torsion spring (not shown) is provided between the disks 192 and 194 to bias the fingers of the disks toward each other (see FIG. 1).

In the present embodiment, the fingers 193 and 195 are preferably covered with elastomeric material to prevent accidental slippage of the device 10 held by the fingers.

As depicted in FIG. 1, the holding mechanism 190 is adapted to hold an electronic device 10. The device 10 could be, for example, a guitar tuner, a chord display, a camera, a recording device, etc. Understandably, the present invention is not limited to any particular kind of devices as the support 100 is preferably more or less universal. Still, the kind of devices 10 is generally limited by the holding capacity of the holding mechanism 190.

To mount the support 100 to the strings S, the user only needs to slide the plates 110 and 130 respectively over the strings S and the elastomeric layers 120 and 140 will frictionally engage the strings S. To remove the support 100, the user only needs to pull the plates hard enough to overcome the static friction between the elastomeric layers 120 and 140 and the strings S. Understandably, the static friction between the elastomeric layers 120 and 140 should be high enough to prevent the device 100 from accidentally falling or slip from the strings S.

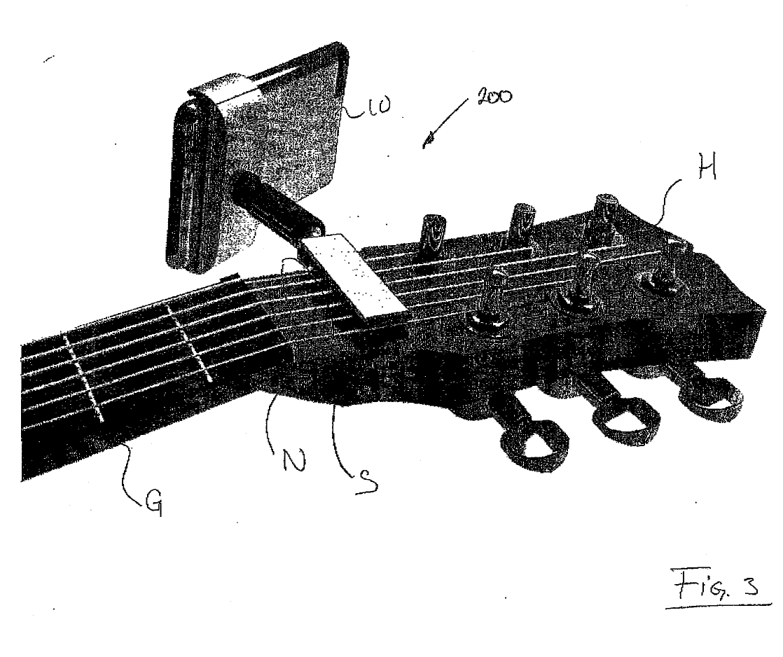

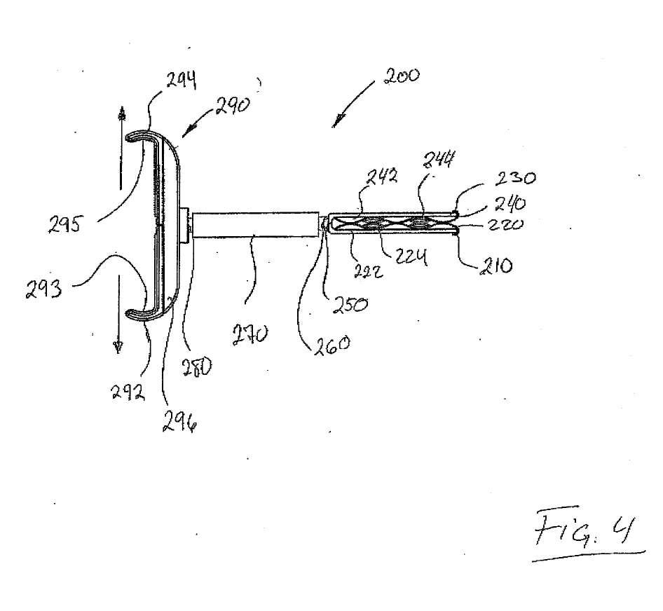

Referring now to FIGS. 3 and 4, a second exemplary support 200 is shown. The support 200 is a variant of the support 100. In that sense, support 200 similarly comprises two plates 210 and 230 joined by a joining portion 250. The plates 210 and 230 are similarly provided with elastomeric layers 220 and 240 facing and preferably contacting each other. As in support 100, elastomeric layers 220 and 240 are preferably respectively provided with alternating ridges 222 and valleys 224, and ridges 242 and valleys 244.

As in support 100, support 200 comprises, preferably at the joining portion 250, a ball joint 260 or any similar joint mechanism. However, in support 200, the joint 260 is connected to an elongated member 270, itself connected to a holding mechanism 290 via preferably another ball joint 280.

The elongated member 270 provides for additional extension between the holding mechanism 290 and the plates 210/230, thus providing more clearance between the holding mechanism 290 and the head H of the instrument G.

Though shown as a rigid element, the member 270 could possibly be telescopic and thus further adjustable in length. Member 270 could also be deformable and flexible.

As is evident from FIGS. 2 and 4, the holding mechanism 290 differs from the holding mechanism 190. The holding mechanism 290 is embodied as two L-shaped plates 292 and 294 slidingly mounted to a support structure 296. The L-shaped plates 292 and 294 can therefore slide with respect to the support structure 296 as shown by the arrows. Still, the L-shaped plates 292 and 294 are preferably biased toward each other with springs (not shown) in order to clamp the device 10 mounted therebetween as best depicted in FIGS. 3 and 4.

To provide a better grip on the device 10, the interior surfaces of the L-shaped plates 292 and 294 can respectively be provided with layers 293 and 295 of elastomeric material.

Referring now to FIG. 5, a third exemplary support 300 is shown. Support 300 also comprises a pair of opposing and laterally extending plates 310 and 330. The plates 310 and 330 are respectively provided with layers 320 and 340 comprising elastomeric material. Layers 320 and 340 are also respectively provided with alternating ridges 322 and valleys 324, and ridges 342 and valleys 344. Contrary to supports 100 and 200, in support 300, the ridges 322 are aligned with valleys 344 and conversely, ridges 342 are aligned with valleys 324.

In support 300, plates 310 and 330 are coupled together by a biasing mechanism 350 such as a spring. The spring 350 urges the two plates toward each other such as to be able to clamp the strings S of the instrument G. To unclamp the support 300, the plates 310 and 330 are respectively provided with protruding portions 315 and 335 which are adapted to be depressed toward each other by the fingers of the user.

As shown in FIG. 5, support 300 is further provided with a ball joint 360 which is mounted, in this third embodiment, to one of the plates 310 or 330. Connected to the ball joint 360 is an elongated member 370 having another ball joint 380 mounted at its other end. Though not shown, a holding mechanism such as, but not limited to, the holding mechanisms 190 and 290, would generally be mounted to the ball joint 380.

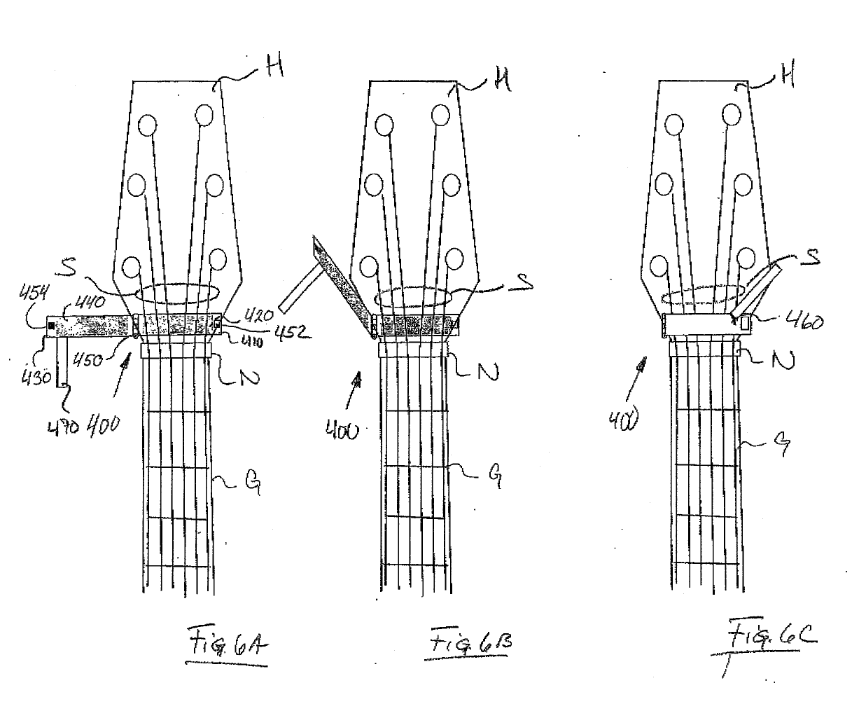

Referring now to FIGS. 6A to 6C, a fourth embodiment of a support 400 is depicted.

Support 400 comprises two plates 410 and 430 respectively provided with elastomeric layers 420 and 440. Plates 410 and 430 are connected, at one of their ends, by a hinge 450, and respectively comprise, at their other end, locking mechanisms 452 and 454. Locking mechanisms 452 and 454 work in cooperation to secure the two plates 410 and 430 together when they are adequately installed over the strings S of the instrument G. Installation of the support 400 is best depicted through FIGS. 6A to 6C.

First, referring to FIG. 6A, the lower plate 410 is slid underneath the strings S of the instrument G. Then, as shown in FIG. 6B, the plate 430 is folded over the strings S, via the hinge 450, until the locking mechanism 454, located on plate 430, engages the complementary locking mechanism 452 located on plate 410. Once the two locking mechanisms 452 and 454 are properly interlocked, the support 400 is secured to the strings S.

Understandably, several locking mechanisms 452 and 454 could be used. The present invention is not limited to any particular locking mechanisms 452 and 454.

As shown in FIG. 6C, the support 400 is further provided with a ball joint 460 which is mounted, in this fourth embodiment, to one of the plates 410 or 430. Connected to the ball joint 460 is an elongated member 470. Though not shown, a holding mechanism such as, but not limited to, the holding mechanisms 190 and 290, would typically be mounted at the free extremity of the elongated member 470, directly or via another ball joint (not shown).

Understandably, while the present embodiments of the invention have been described as comprising layers of elastomeric material on the respective plates of the support, it is to be understood that the expression “elastomeric material” should be construed broadly such as to encompass other materials exhibiting properties (e.g. resiliency, friction, adherence, etc.) similar to those of commonly known elastomeric materials such as rubber. Hence, the present invention is not necessarily limited to commonly known elastomeric materials.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A support for use on a stringed instrument, said support comprising:
a) a clamping mechanism comprising:
i) a first laterally extending plate having a first side and second side, said first side comprising mounted thereto a first layer comprising an elastomeric material;
ii) a second laterally extending plate having a third side and a fourth side, said third side comprising mounted thereto a second layer comprising an elastomeric material;
iii) a connecting element coupling said first plate and second plate together such as to be able to frictionally engage at least one string of said stringed instrument;
b) a holding mechanism coupled to said clamping mechanism and configured to hold a device.

2) A support as claimed in claim 1, wherein said first layer comprises a series of alternating ridges and valleys.

3) A support as claimed in claim 2, wherein said second layer comprises a series of alternating ridges and valleys.

4) A support as claimed in claim 3, wherein said alternating ridges and valleys of said first layer and said alternating ridges and valleys of said second layer are respectively aligned.

5) A support as claimed in claim 3, wherein said alternating ridges and valleys of said first layer and said alternating ridges and valleys of said second layer are respectively offset.

6) A support as claimed in claim 1, wherein said connecting element is a connecting portion linking said first plate and said second plate.

7) A support as claimed in claim 6, wherein said connecting portion resiliently biases said first plate and said second plate toward each other.

8) A support as claimed in claim 7, wherein said first layer and said second layer are at least partially contacting each other.

9) A support as claimed in claim 6, wherein said clamping mechanism is substantially U-shaped.

10) A support as claimed in claim 6, wherein said clamping mechanism is unitary.

11) A support as claimed in claim 1, wherein said connecting element is a spring connected both to said first plate and to said second plate, said spring biasing said first plate and said second plate toward each other.

12) A support as claimed in claim 11, wherein said first plate further comprises a first protruding portion extending beyond said spring and wherein said second plate further comprises a second protruding portion extending beyond said spring.

13) A support as claimed in claim 1, wherein said connecting element is a hinge whereby said first plate can pivot with respect to said second plate.

14) A support as claimed in claim 13, wherein said first plate comprises a first locking mechanism and wherein said second plate comprises a second locking mechanism, said first and second locking mechanisms being configured to engage each other in a locking arrangement.

15) A support as claimed in claim 1, wherein said holding mechanism is connected to said clamping mechanism via a ball joint.

16) A support as claimed in claim 1, wherein said holding mechanism is connected to said clamping mechanism via two ball joints and an elongated member, said ball joints being respectively located at each extremity of said elongated member.

17) A support for use on a stringed instrument, said support being configured to support a device, said support comprising a substantially U-shaped clamp comprising a first laterally extending portion comprising a first side, a second side, and a first layer comprising elastomeric material mounted to said first side, a second laterally extending portion comprising a third side, a fourth side, and a second layer comprising elastomeric material mounted to said third side, and a connecting portion connecting said first portion and second portion together, said first and second layers facing each other and at least partially contacting each other such as to be able to frictionally engage at least one string of said stringed instrument, said support further comprising a holding mechanism coupled to said clamp and configured to hold said device.

18) A support as claimed in claim 17, wherein said holding mechanism is connected to said clamp via a ball joint.

19) A support as claimed in claim 17, wherein said holding mechanism is connected to said clamp via two ball joints and an elongated member, said ball joints being respectively located at each extremity of said elongated member.
